(19) United States
(12) Patent Application Publication
(10) Pub. No.: US 2004/0034440 A1
(43) Pub. Date: Feb. 19, 2004

(54) Golf handicap and merchandising kiosk

(76) Inventor: Richard Middlebrook, Boca Raton, FL (US)

Correspondence Address: MCHALE & SLAVIN, P.A., 2855 PGA BLVD, PALM BEACH GARDENS, FL, 33410, US

(21) Appl. No.: 10/219,982

(22) Filed: Aug. 14, 2002

(51) Int. Cl. G06F 155/00

(52) U.S. Cl. 700/91

(57) ABSTRACT

An integrated system of golf handicapping and advertising uses a computer to calculate a new golf handicap from entered scores and stored scores. In addition, advertising material is presented, by computer, to be perused in the same location. A printer connected to the computer can print out promotional material or coupons for redemption at sale.

### FIELD OF THE INVENTION

This invention is related to the field of golf, particularly golf handicap scoring and club house equipment.

### BACKGROUND OF THE INVENTION

At almost every golf course there is a golf shop or pro shop. This facility is usually operated by a golf professional who is a member of the USGA (United States Golf Association) or the PGA (Professional Golf Association). One of the functions of the golf shop and the golf pro is to control the play on the golf course. Also, the golf pro is responsible for setting handicaps for the players or members at the golf course.

Because golf is a universal game with players of all abilities, a system of handicapping golfers has been established by the USGA. This standard handicap is recognized at almost every golf course and golf club. A golfer's handicap allows him to compete with other golfers on a relatively equal basis. Therefore, most golfers want to establish and continually update a recognized handicap. To do this every score should be entered in the handicapping system at the close of play. The golf shop or pro shop has the ability to provide this service. So most golfers return to the pro shop or the golf shop following completion of a round of golf to enter their scores in the handicap system.

The golf shop or the pro shop also merchandise essential equipment and accessories for the game of golf. This boutique shop may account for a substantial part of the income of the golf course or golf club. Further, there is intense sales competition among manufacturers of these accouterments and services.

What is needed in the field is to direct golfers' attention to the competitors wares, while they are completing a necessary step of playing golf.

This is particularly important at courses and clubs where the handicapping equipment is located in a locker room or other space separated from said golf shop. At those courses and clubs, the golfers may never pass by or be attracted to the merchandise.

### DESCRIPTION OF THE PRIOR ART

U.S. Pat. No. 6,074,312 issued Jun. 13, 2000, incorporated herein by reference, discloses a golf handicapping system and a terminal or local processing unit to enter the individual scores of a participating golfer and dispense a handicap. The LPU may have programming with other applications including medical information, credit cards etc. The preferred product is a “smart card” application wherein the card is inserted in a slot in the LPU. The LPU is also capable of displaying videos.

U.S. Pat. No. 4,195,920 issued Apr. 1, 1980 discloses a display screen which is used in a virtual golf game. The device has a screen saving application which includes an advertising scene.

Neither of these patents teach a golf system having a golf handicapping application in combination with an advertising application including issuing written handicaps and information or discount coupons about certain advertised products or services.

### SUMMARY OF THE INVENTION

A golf handicap and interactive advertising kiosk for entering scores and disseminating selected information by a user. The kiosk is a free standing cabinet housing at least one computer with a I/O port, RAM, ROM, a display and a printer. The cabinet has an entry panel for gaining access to said computer, a window with a display including a screen fixed in the cabinet to be viewed through the window. The cabinet has an opening supporting a data input device, the data input device connected to the I/O port, the screen including touch data input connected to the I/O port. The computer has a golf handicap application which averages scores entered by the data input device with RAM scores to produce a golf handicap. The scores and golf handicaps are viewable on the display, the computer has an advertising application for producing visual images on the screen. The visual images being touch sensitive for touch data input whereby touching an image brings up more information concerning the image.

Accordingly, it is an objective of the instant invention to provide an integrated system for recording golf scores and advertising goods and services.

It is a further objective of the instant invention to provide an enclosure housing the integrated system.

It is yet another objective of the instant invention to provide an interactive system whereby a scorer may enter scores and, upon demand, receive a printed golf handicap and, additionally, can select certain products or services, among those presented, for which printed information or promotional material is issued.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE FIGURES

FIG. 1 is a front perspective of a kiosk of this invention;

FIG. 2 is a side perspective of the kiosk of this invention; and

FIG. 3 is a flow sheet of the advertising application of this invention.

### DETAILED DESCRIPTION OF THE INVENTION

The golf handicap and advertising system is preferably located at a kiosk 10 to assure that the advertising application is readily available and noticeable to the user of the handicapping application. The kiosk 10 has a cabinet 11 which is a free standing enclosure capable of housing and supporting one or two computers with the attendant peripherals connected by an input-output port (I/O Port), such as a monitor, printer, keyboard, mouse and modem.

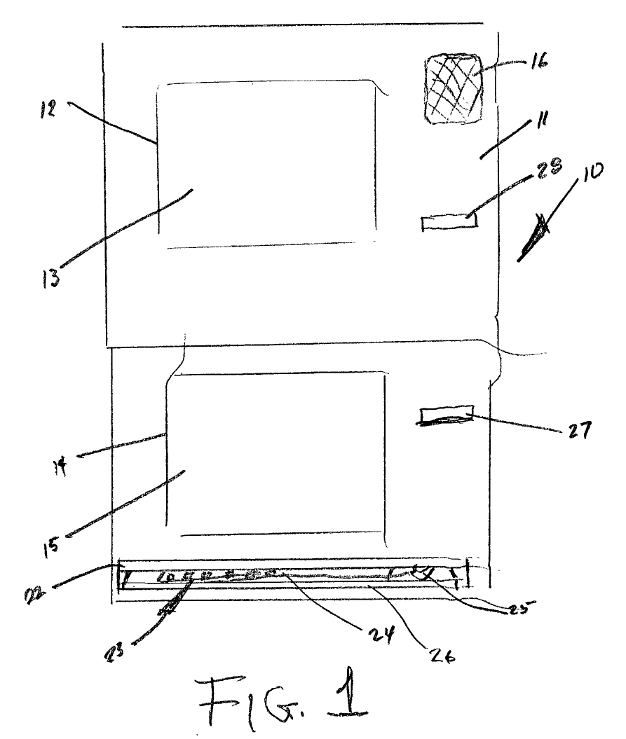

The cabinet 11 may be made of wood, metal, plastic or other material with the requisite strength and appearance characteristics having a front, opposite side walls and a back. The front of the cabinet has a window or opening 12 for viewing the monitor screen 13 of a computer. The monitor may be mounted on or supported by a shelf or brackets (not shown) integral with the cabinet 11. As shown in FIG. 1, the front of the cabinet has another window 14 for viewing the monitor screen 15 of a second computer. The second monitor may also be mounted or supported by another shelf or brackets in the cabinet. As shown, the windows are in vertical relationship with one another. However, the cabinet could be shaped to provide windows horizontally related to each other or at some other angular relationship. The screens 13 and 15 are touch sensitive for data input by user's touch or by mouse or by both.

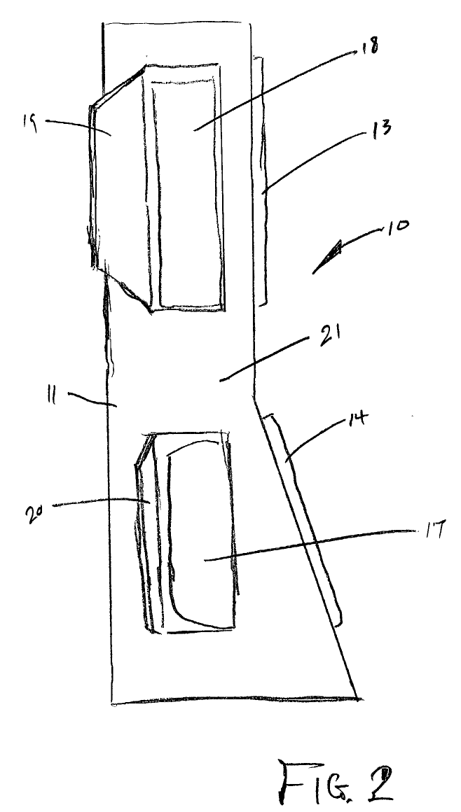

At least one speaker is connected with one or both computers 17 and 18, shown in FIG. 2. As shown, the speaker is located behind the grill 16. Of course, the speaker or speakers may be otherwise associated with the cabinet.

Also shown in FIG. 2 is the side wall 21 of the cabinet with hinged panels 19 and 20 serving as security doors for accessing the computers 17 and 18 which are supported inside the cabinet 11. The access panel may be located on any wall of the cabinet and may be one large panel or the back of the cabinet (not shown) could be entirely open.

Across the bottom of the cabinet 11 is an opening 22 for gaining access to the data input device 23 which may be a keyboard 24 and/or a mouse 25. The keyboard and mouse are supported by a planar shelf 26 that is slidable into and out of the cabinet. The keyboard and/or mouse may be connected to one or both computers 18 and 19 for entering data in the selected computer.

The front of the cabinet 11 has a slot 27 for delivery of a golf handicap print-out. This may be in the form of a card or a label which may be applied to a pre-existing card or other format. The slot 27 is connected to the output of a printer (not shown) located in the cabinet. The kiosk 10 may have one printer connected to both computers 18 and 19 or a separate printer for each computer.

FIG. 1 illustrates a second slot 28 for delivery of printed material concerning the advertised goods and services. The second slot 28 may connect to a second printer or it may connect with one printer but delivers material in a substantially different format. The slots 27 and 28 are shown as being approximately the same size but may be significantly different.

The kiosk 10 provides a convenience for integrating a near mandatary function of playing golf with the opportunity to inform the golfer about various golf equipment, wares and promotions currently available to him.

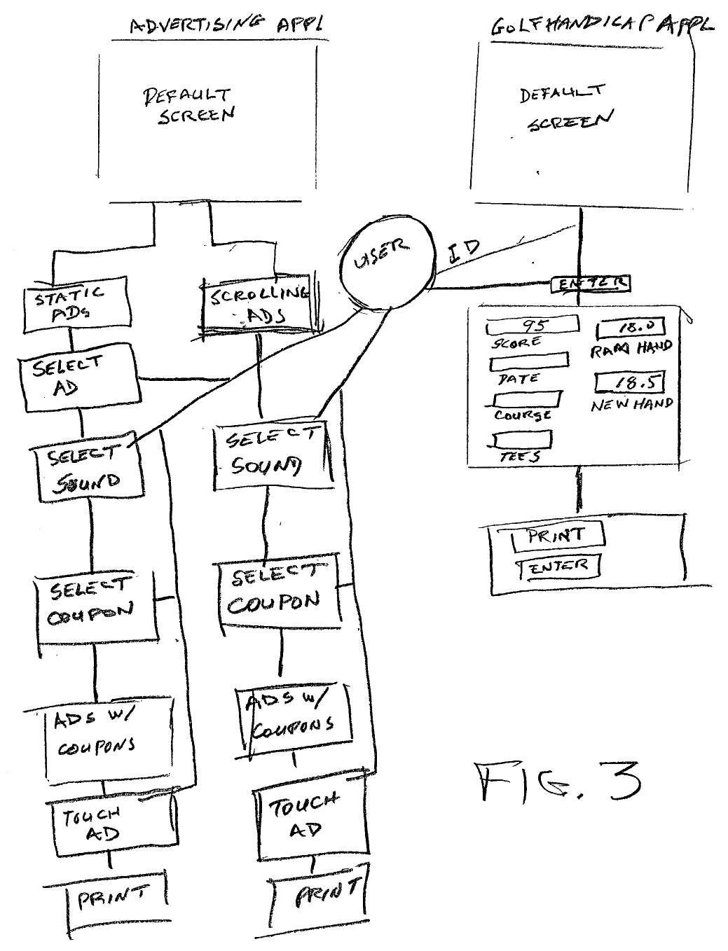

FIG. 3 shows the steps of the advertising application which is part of the programming of a computer within the system. The preferred embodiment of the advertising application presents visual images of an advertisement on a monitor screen, as a default screen. These images could be static or scrolled in a continuous loop across the screen. With the static ads, the user will select one ad by touch sensitive screen capability. With the continuous scrolling ads, the ad on the screen is the active ad. The default screen also contains a sound command area and a coupon area.

If the user touches or otherwise activates the sound command which may be a particular area of the touch screen. The sound for the selected ad is then produced by the speaker. Once the sound track for the ad is broadcast, the speaker is silent until the command is selected again. This is to prevent the sound tracks from being continuously broadcast. This noise interrupter may be dispensed with, if desired.

If a selected ad or a scrolled ad on the screen is touched, the touched ad replaces the default screen with a full screen display of the ware. The sound command may be included with this screen. Also, the coupon area may be included with the full screen display. By touching the coupon area, a print command activates the printer to produce written promotional material, such as discount coupons or more specific information.

If the coupon area on the default screen is activated, a screen having the ads with associated coupons will replace the default screen. Touching any one of those selected ads will produce the coupon for that ad.

The golfer may initially, subsequently or simultaneously activate the golf handicapping application. This programming includes an algorithm that is approved and/or licensed by the USGA to produce a standardized handicap usable at most golf courses and clubs. The application may also contain one or more algorithms for calculating other handicap systems used in match play or tournament play.

The application will ask the golfer or user for identification to locate the correct set of stored data. The screen will require input of specific information about the current entry, such as number of strokes, the course played, the set of tees played from or the length of the course, the slope of the course, the date of the score, etc. Once the entry is complete, the new handicap is calculated. A print out of the new handicap may be commanded. The print out may be in the form of a label to be attached to a handicap card or a new card or some other format. Of course, audits of all or some of the entries may be printed on command.

By use of a modem, both applications can transmit and receive information and programming to update the applications. Such capability may or may not include the Internet. For example, ads changed, deleted or added and course characteristics changed, courses added or deleted.

In the preferred embodiment, the kiosk has two computers with one computer running the golf handicap application and the other running the advertising application. The default page of the advertising application has scrolled ads on the screen with a sound button. By touching the screen sound button, the sound for an ad that is currently on the screen is heard. A coupon button is also on the screen. By touching the coupon button, another page comes on the screen with several images of ads that have associated printed material or discount coupons. By touching one of these ads, the printed material is produced by the printer.

The first computer runs the golf handicapping application with drop-down windows asking for particular information about the golfer and the course, scores, etc. When these windows are filled in, the new handicap is calculated and printed, if commanded.

Either or both, computers may have a modem by which the applications may be accessed.

It is to be understood that while a certain form of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

What is claimed is:

1. A golf handicap and interactive advertising kiosk for entering scores and disseminating selected information by a user, said kiosk comprising a free standing cabinet housing at least one computer with a I/O port, RAM, ROM, a display and a printer, said cabinet having an entry panel for gaining access to said computer, said cabinet having a window, said display including a screen fixed in said cabinet to be viewed through said window, said cabinet having an opening supporting a data input device, said data input device connected to said I/O port, said screen including touch data input connected to said I/O port, said computer having a golf handicap application which averages scores entered by said data input device with RAM scores to produce a golf handicap, said scores and said golf handicap viewable on said display, said computer having a advertising application for producing visual images on said screen, said visual images being touch sensitive for touch data input whereby touching an image brings up more information concerning said image.

2. A golf handicap and interactive advertising kiosk of claim 1 wherein said scores and said handicap viewable on said screen are printed by said golf handicap application with said printer.

3. A golf handicap an interactive advertising kiosk of claim 1 wherein said touching includes physical contact by a user, said touching of an image prints out coupons.

4. A golf handicap and interactive advertising kiosk of claim 3 wherein a mouse is connected to said I/O port, said touch data input is activated by said mouse.

5. A golf handicap and interactive advertising kiosk of claim 1 wherein said cabinet has a third opening, a speaker mounted in said cabinet adjacent said third opening, said speaker connected to said I/O port of said computer.

6. A golf handicap and interactive advertising kiosk of claim 5 wherein said speaker is responsive to said golf handicap application.

7. A golf handicap and interactive advertising kiosk of claim 5 wherein said speaker is responsive to said advertising application.

8. A golf handicap and interactive advertising kiosk of claim 7 wherein said speaker is responsive to said golf handicap application.

9. A golf handicap and interactive advertising kiosk of claim 1 wherein said cabinet has a slot, said slot connected to said printer for issuing coupons.

10. A golf handicap and interactive advertising kiosk of claim 1 wherein said computer includes a modem connected to said I/o port.

11. A golf handicap and interactive advertising kiosk of claim 1 wherein said golf handicap application includes an algorithm for producing a standard handicap approved by the USGA.

12. A golf handicap and interactive advertising kiosk of claim 11 wherein said golf handicap application includes other algorithms for producing other golf handicaps.

13. A golf handicap and interactive advertising kiosk of claim 1 wherein said advertising application includes said visual images having an associated sound track, upon touching one of said images said associated sound track is activated.

14. A golf handicap and interactive advertising kiosk of claim 13 wherein said advertising application includes programming to associate a printed coupon with some of said images wherein a button on said touch screen activates said printer to print said coupon.

15. A golf handicap and interactive advertising kiosk of claim 14 wherein said advertising application includes programming to produce several visual images simultaneously and touching of said button selects only those images with associated coupons, touching of one of said selected images prints said associated coupon.

16. A golf and interactive advertising kiosk of claim 15 wherein said visual images may be any one of the group selected from full motion videos, still screen ads, or animated ads and said visual images are continuously produced on said screen.

17. A golf handicap and interactive advertising kiosk of claim 16 wherein said cabinet houses at least two computers, a first computer with a first I/O port, a first RAM, a first ROM, a first display and a first printer, a second computer with a second I/O port, a second RAM, a second ROM, a second display and a second printer, said cabinet having at least one entry panel for gaining access to said first and second computers, said cabinet having at least two windows, said first display including a first screen fixed in said cabinet to be viewed through one of said at least two windows, said second display including a second screen fixed in the other of said at least two windows, said data input device connected to said first and second I/O ports, respectively, said first and said second screens including touch data inputs connected to said first and said second I/O ports, respectively, one of said at least two computers having said golf handicap application, the other of said at least two computers having said advertising application.

18. A golf handicap and interactive advertising system for recording golf scores and calculating a golf handicap combined with a promotional exhibit for a user, said system comprising at least two computers, a first computer with a first I/O port, a first RAM, a first ROM, a first monitor and a first printer, a second computer with a second I/O port, a second RAM, a second ROM, a second monitor and a second printer, said first monitor including a first screen, said second monitor including a second screen, a data input device connected to said first and second I/O ports, respectively, an audio speaker connected to at least said second computer, at least one of said first and said second screens including touch data inputs connected to at least one of said first and said second I/O ports, respectively, one of said at least two computers programmed with a golf handicap application, the other of said at least two computers programmed with an advertising application, said golf handicap application including an algorithm whereby scores entered by said data input device are compared with stored scores to calculate a new golf handicap, said scores displayed on said first screen, and said handicap printed by said first printer, said advertising application including projecting several visual images on said second screen, said visual images being one of the group consisting of full motion videos, still screen ads or animated ads, some of said several images having an associated soundtrack, said speaker audiblizing said soundtrack when an associated visual image is selected, some of said several visual images having a printing command associated therewith, said printing command causing said associated visual images to be highlighted on said second screen, said printing command executed by touching a highlighted visual image and said second printer printing a coupon.

19. A golf handicap and interactive advertising system of claim 18 wherein said data input device is one of the group consisting of a mouse or a keyboard or a combination of a mouse and a keyboard.

20. A golf handicap and interactive advertising system of claim 19 wherein one of said two computers has a means for accessing the Internet.
